(19) United States
(12) Patent Application Publication
(10) Pub. No.: US 2015/0208849 A1
(43) Pub. Date: Jul. 30, 2015

(54) Infusers and Infusion Devices

(71) Applicant: Epoca International, Inc., Boca Raton, FL (US)

(72) Inventors: Brian Melzer, Boca Raton, FL (US); Paul Robert Goetz, Maple Grove, MN (US); Shi Kai Tan, Blue Horizon (SG); Ricardo Eduardo Malachowski Gandolfo, Shenzhen (CN); LiXin Zhang, Shenzhen (CN); Yu Tong Wu, Columbus, OH (US); Dylan Notestine, Cincinnati, OH (US)

(73) Assignee: Epoca International, Inc., Boca Raton, FL (US)

(21) Appl. No.: 14/166,079

(22) Filed: Jan. 28, 2014

(51) Int. Cl. A47J 31/00; A47J 31/44

(52) U.S. Cl. CPC A47J 31/005; A47J 31/4403

(57) ABSTRACT

An infuser for containing an infusion item includes an a first hollow body, a filter permeable to an infusion component derived from the infusion item, and a first internal volume at least partially defined by the first hollow body and the filter. The first internal volume is dimensioned to receive the infusion item therein. The first hollow body includes an elastomeric material deformable upon application of a deformation force to compress the first internal volume.

### TECHNICAL FIELD

The present description relates generally to infusion of liquids and, more specifically, to infusers and infusion devices for convenient and accelerated infusion of liquids.

### BACKGROUND

Flavor or added nutrition may be imparted to liquids by mixing or otherwise infusing the liquid with infusion components. For example, an infusion may be formed by steeping an infusion item such as fruits, vegetables, herbs, or other plant materials in a liquid. Over time, infusion components derived from the infusion item such as juices, oils, nutrients, flavors, and other compounds dissolve or otherwise mix with the liquid to provide a flavorful and nutritious beverage. However, conventional devices and methods for creating customized infusions are often too complex or time consuming for busy consumers. What is needed is a device allowing consumers to quickly and conveniently create potable infusions using personalized quantities and combinations of infusion items and liquids.

### FIGURES

The novel features of the described embodiments are set forth with particularity in the appended claims. The described embodiments, however, both as to organization and manner of operation, may be best understood by reference to the following description, taken in conjunction with the accompanying drawings in which:

FIG. 1A is an exploded view in perspective of an infuser according to various embodiments described herein;

FIG. 1B is a cross-sectional view of the infuser illustrated in FIG. 1A taken along line 1B-1B;

FIG. 1C is an elevated view in perspective of the infuser illustrated in FIG. 1A wherein the hollow body is shown deformed such that the internal volume is deformed according to various embodiments described herein;

FIG. 1D is a cross-section view of the infuser having a deformed internal volume shown in FIG. 1C taken along line 1D-1D according to various embodiments described herein;

FIG. 2 is an elevated view in perspective of an infusion device according to various embodiments described herein;

FIG. 3 is an elevated view in perspective of the infusion device illustrated in FIG. 2;

FIG. 4 is a top view in perspective of the infusion device illustrated in FIG. 2;

FIG. 5 is an exploded view in perspective of the infusion devices illustrated in FIGS. 2-3;

FIG. 6 is an exploded view in perspective of the infusion device illustrated in FIGS. 2-3;

FIG. 7 is a cross-section view in perspective of the infusion device illustrated in FIG. 4 taken along line 6-6; and

FIG. 8 is a cross-section view in perspective of the infusion device illustrated in FIG. 5 taken along line 7-7.

### SUMMARY

In one aspect, the various embodiments disclosed herein are directed to an infuser comprising a first hollow body, a filter permeable to an infusion component derived from an infusion item, and a first internal volume. The first internal volume is at least partially defined by the first hollow body and the filter and is dimensioned to receive the infusion item therein. The first hollow body comprises an elastomeric material configured to deform upon application of a deformation force to deform the first internal volume.

In one embodiment, deformation of the elastomeric material to deform the first internal volume is configured to compress the hollow body against the infusion item to promote extraction of the infusion component from the infusion item when the infusion component is received within the first internal volume. In another embodiment, the first hollow body further comprises one or more muddling features positioned within the first internal volume configured to muddle the infusion item when the hollow body portion is compressed against the infusion item. In another embodiment, the infuser comprises a fitting configured to couple the first hollow body to a second hollow body. The second hollow body defines a second internal volume configured to receive a liquid to be infused with the infusion component. When the first hollow body is coupled to the second hollow body, the filter is positioned between the first internal volume and the second internal volume. In one embodiment, the infuser further comprises a partition wherein the filter comprises a plurality of liquid permeable channels formed through the partition. The partition comprises one or more muddling features positionable within the first internal volume structured muddle the infusion item when the first hollow body portion is compressed against the infusion item. In another embodiment, at least one of the partition and the second hollow body comprises a rigid material configured to transmit at least a portion of the deformation force.

In one embodiment, the first hollow body comprises one or more walls that define the internal volume. The one or more walls comprise a first wall portion, a second wall portion, and a third wall portion. The at least the third wall portion comprises the elastomeric material and is configured to be elastically deformable between a first conformation and a second conformation. A distance between the first wall portion and the second wall portion is changed in the second conformation. The third wall portion may be configured to elastically deform from the first conformation to the second conformation upon application of the deformation force and return to the first conformation upon removal of the deformation force. The second conformation may comprise a variable conformation at least partially dependent upon at least one of an angle and magnitude of the deformation force applied. In one embodiment, the second conformation comprises a plurality of second conformations and, in at least one of the plurality of second conformations, the first wall portion is rotated with respect to the second wall portion.

In another aspect, an infusion device for infusing a liquid with an infusion component derived from an infusion item. The infusion device comprises a first hollow body, a second hollow body, and a partition. The first hollow body portion defines a first internal volume configured to receive the infusion item therein and is deformable upon application of a deformation force to transition the first internal volume from a first form to a second form. The first hollow body is configured to compress the infusion item within the first internal volume when transitioned from the first form to the second form to promote extraction of the infusion component from the infusion item. The second hollow body portion defines a second internal volume configured to receive the liquid to be infused and is configured to stably associate with the first hollow body portion. The partition is configured to be positioned between the first internal volume and the second internal volume when the second hollow body portion is stably associated with the first hollow body portion. The partition comprises a filter configured to be permeable to the infusion component, and wherein the second internal volume is configured to receive the infusion component from the first hollow body portion.

In some embodiments, the infusion device further comprising one or more muddling features configured to be positioned within the first internal volume and structured to muddle the infusion item when the first hollow body compresses the infusion component. At least one of the first wall and the second wall may comprise one or more of the one or more muddling features. The second hollow body portion may comprise a rigid material configured to at least partially transmit the deformation force at the second end. The one or more muddling features may comprise a metal. The elastomeric material may comprises a silicone. In one embodiment, the infusion device further comprises a cap configured to couple to the second hollow body and defining a fluid port pluggable to fluidically seal the first and second internal volumes, wherein the cap comprises a removable cup for consuming an infused liquid, and wherein the removable cup comprises a third hollow body portion defining a third internal volume and comprising a first closed end comprising a coverplate defining the fluid port and a second open end defining an annular rim. In one embodiment, the infusion device comprises a handheld infusion bottle.

In one embodiment, the first hollow body portion comprises a first end, a second end, and one or more walls positioned therebetween defining the first internal volume. The one or more walls may comprise an elastomeric material configured to reversibly deform when the deformation force is applied between the first end and the second end to transition the first internal volume from the first form to the second form. A distance between the first end and the second end is reduced when the first internal volume is transitioned from the first form to the second form. In one embodiment, the first hollow body comprises the partition and the one or more walls comprise a first wall positioned at a first end of the first hollow body, a second wall positioned at a second end of the first hollow body, and one or more third walls positioned therebetween. The one or more third walls may also comprise an elastomeric material configured to reversibly deform when the deformation force is applied between the first end and the second end to transition the first internal volume from the first form to the second form such that a distance between the first wall and the second wall is reduced when the first internal volume is transitioned from the first form to the second form.

### DESCRIPTION

Before explaining various embodiments of infusers and infusion devices in detail, it is noted that the illustrative embodiments are not limited in application or use to the details of construction and arrangement of components illustrated in the accompanying drawings and description. That is, the illustrative embodiments may be implemented or incorporated in other forms, variations and modifications, and may be practiced or carried out in various ways. Furthermore, unless otherwise indicated, the terms and expressions employed herein have been chosen for the purpose of describing the illustrative embodiments for the convenience of the reader and are not for the purpose of limitation thereof.

Furthermore, it is understood that any one or more of the following-described embodiments, expressions of embodiments, and examples thereof may be combined with any one or more of the other following-described embodiments, expressions of embodiments, and examples.

The various embodiments described herein are directed to improved infusers and infusion devices. In general, the infusers and infusion devices are configured for accelerated infusion of a liquid with one or more infusion components derived and extracted from one or more infusion items. For example, in one embodiment, an infuser or infusion device is configured for convenient infusion of liquid on a personal scale, which may, for example be on a portable or consumer scale. It should be understood, however, that the infusers and infusion devices disclosed herein are not so limited. For example, infusers or infusion devices on a larger scale, employing the same or similar principles disclosed herein, may also be used to achieve convenient infusion of liquid. Such versatility of the present disclosure with respect to the embodiments described herein is therefore understood to be within the scope of the present disclosure.

According to various embodiments, infusions include liquids containing or mixed with infusion components comprising chemicals, flavors, oils, juices, or other components of an infusion item that may be extracted, e.g., dissolved, diffused, separated, released or otherwise derived from the infusion item. For example, in some embodiments, the infusion may include mixtures comprising solutions, which may include undissolved substances such as pulp or other infusion item tissues, emulsifications, colloids, decoctions, or percolations.

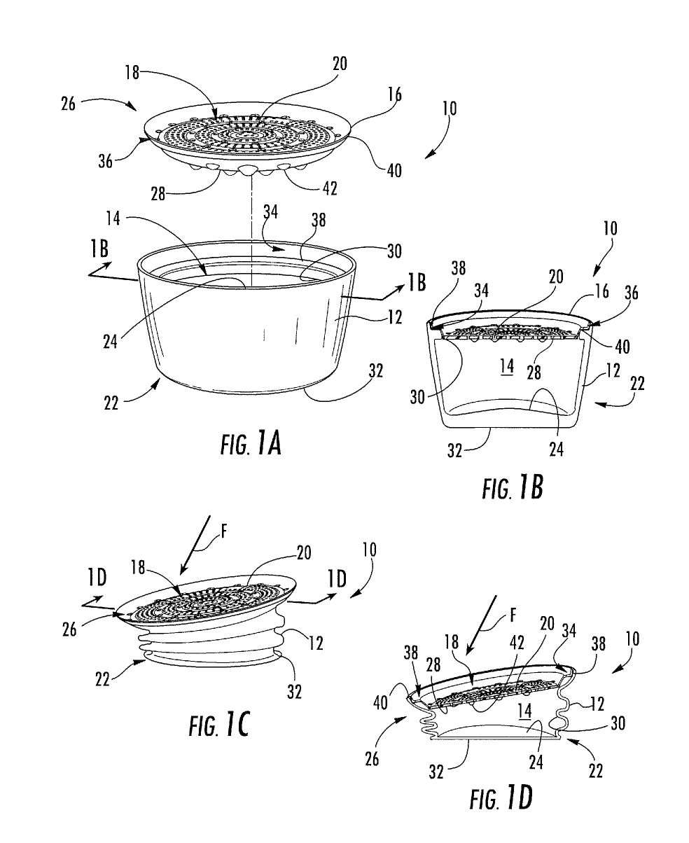

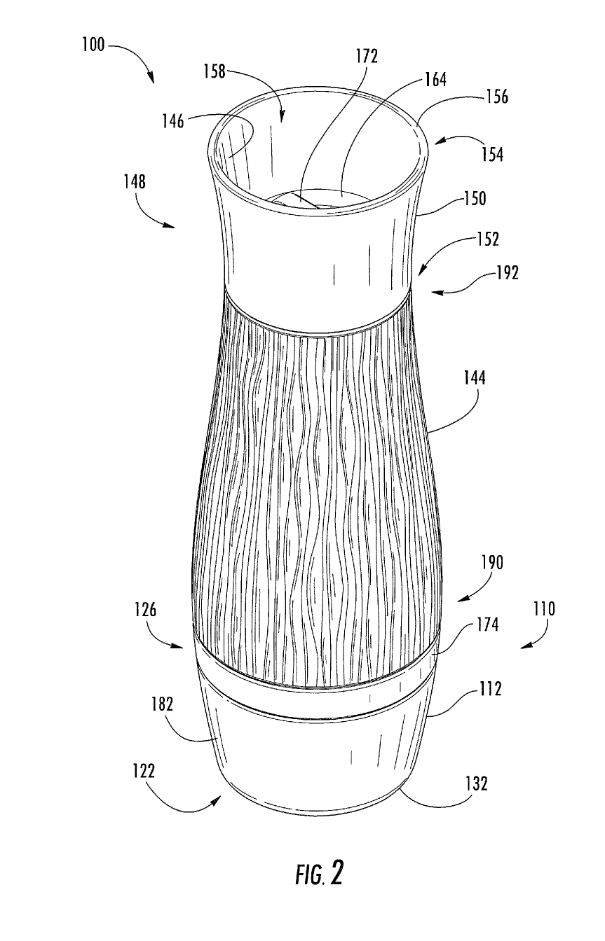

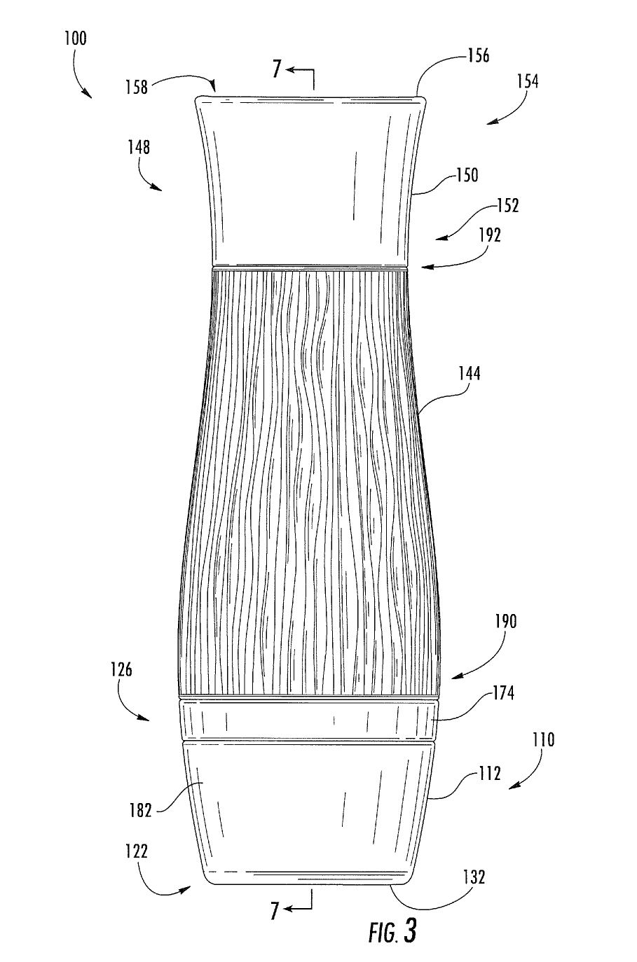

FIG. 1A illustrates an exploded view in perspective of one embodiment of an infuser 10. FIG. 1B shows a cross-sectional view of the infuser of FIG. 1A taken along line 1B-1B. The infuser 10 comprises a container including a hollow body 12 at least partially defining an internal volume 14. The internal volume 14 is dimensioned to receive an infusion item, e.g., fruits, vegetables, herbs, plant materials, etc. In one embodiment, for example, an infuser 10 may define one or more various volumes within the internal volume 14 comprising dimensions to suit one or more quantities or combinations of infusion items.

The infuser 10 further comprises a partition 16 configured to be positioned on the container and further define the internal volume 14. The partition 16 comprises a filter 18 extending along a portion thereof. In some embodiments, the partition 16 comprises a frame configured to couple to the filter 18 while in other embodiments the filter 18 is formed on the partition 16. It is noted that, in some embodiments, the hollow body 12 may further comprise the partition 16 or filter 18. The filer 18 is configured to provide a partial barrier between the internal volume 14 and an environment external to the infuser 10, e.g., a liquid contained within a second internal volume defined by a second container or hollow body such as a bottle or beverage pitcher coupled to the infuser 10. As illustrated, the filter 18 comprises a plurality of liquid permeable channels 20 extending through the partition 16. The permeability and selectablity of the filter 18 may vary by application. For example, the permeability of the filter 18 may include semi-permeability or liquid permeability, including permeability to the liquid to be infused in addition to various liquids or dissolved infusion components. Furthermore, in some embodiments, the selectability of the filter 18 is based on one or more physical characteristics of the substance to be filtered such as phase, particle size, charge, etc. Depending on the desired application the composition or configuration of the filter 18 may similarly vary. For example, in certain embodiments, the filter 18 may comprise a mesh including one or more layers of paper, metals, alloys, ceramics, rubbers, polymers, or other suitable material. Similarly, in various embodiments, the partition 16 may comprise metals, alloys, ceramics, rubbers, polymers, e.g., hard plastics, which may or may not be the same materials as those of the filter 18.

As introduced above, the infuser 10 comprises a hollow body 12 defining an internal volume 14 configured to receive an infusion item. In various embodiments, the internal volume 14 may be defined between one or more walls. In some embodiments, at least a portion of the one or more walls comprises the partition 18 or filter 18. Additionally, at least a portion of the one or more walls may be selectively movable by any manner known in the art to expose the internal volume 14 such that the infusion item may be received therein. For example, as shown in FIGS. 1A and 1B, the infuser 10 comprises a first end 22 comprising a first wall 24, a second end 26 comprising a second wall 28, and one or more third walls 30 defining the internal volume 14. The first wall 24 comprises a base 32 and the second wall 28 comprises the partition 16 and filter 18, which are selectively movable. For example, the infuser 10 includes one or more fittings 34, 36 configured to secure the filter 18. Such fittings 34, 36 may include any suitable fittings known in the art such as clips, tabs, grooves, or threads 38, 40, as shown in FIG. 1, which may be, for example, configured for rotational, snap, frictional, or compression fitment.

As introduced above, in various embodiments, the infuser 10 is configured such that the internal volume 14 may be deformed. For example, one or more walls 24, 28, 30, the partition 16, or the filter 18 may be structured to deform the internal volume 14 or comprise a deformable material configured to deform upon application of a deformation force. In various embodiments, the deformable material is elastomeric such that the deformable material may be substantially reversibly deformed to a second conformation and then return to a nondeformed or first conformation upon removal of the deformation force. Among suitable deformable or resilient, e.g, elastomeric, materials are shape change or shape memory materials, elastomers, rubbers, foams, thermoplastics, thermosets, including elastomeric polymer compositions such as silicones. According to the various embodiments, the deformable material may be produced by, for example, injection molding, or any other convenient manner known in the art.

In one embodiment, the deformability or elasticity of the material may be assisted by it structure, e.g., one or more walls 24, 28, 30 of portions thereof may fold to a second conformation with respect to each other to deform the internal volume 14 to the second form upon application of a deformation force. In some such embodiments, the foldable wall portions may be configured to unfold to the initial or first conformation upon removal of the deformation force or may be configured to unfold upon application of a reversal force, e.g., applied by the user, to return the internal volume 14 to the first form.

In various embodiments, as illustrated in FIGS. 1A-1D, the hollow body 12 is deformable upon application of a deformation force, shown generally along line F, to transition the internal volume 14 from a first form, as shown in FIGS. 1A and 1B, to a second form, as shown in FIG. 1C and FIG. 1D, in cross-section taken along line 1D-1D of FIG. 1C. For example, according to one operation, an infusion item is received within the internal volume 14 of the infuser 10 and a deformation force is applied to the hollow body 14 such that the deformable material deforms to thereby deform and compress at least a portion of the internal volume 14. According to various embodiments, the deformation force F may be applied by a user, for example, by squeezing, twisting, pushing, or pulling the infuser 10 or portion thereof with a hand or implement. For example, in one embodiment, the user may place the first end 22 against a hard surface and apply pressure to the second end 26 to thereby deform or compress the internal volume 14.

It will be appreciated that in various embodiments the deformation force F may be applied in multiple or various directions and at multiple or various locations of the infuser 10 to deform the internal volume 14. Similarly, for simplicity, the deformation force F is shown as having only a single direction. However, one or more opposing or stationary deformation forces may also be present, for example, at the base 32.

According to various embodiments, a deformation or deformation force F may include one or more of tension, compression, and torsion stresses. In various configurations, the deformation forces F may be applied at one or more positions of the infuser 10 or at one or more angles with respect to an orientation of the infuser 10 to transition the internal volume from the first form to one or more second forms. For example, in one embodiment, a deformation force F causes compressive strain between the first wall 24 and the second wall 28. Such a deformation force F for example, may be configured to deform the internal volume to a second form due to a resulting compressive strain or buckling of the third wall 30, thereby proximating of the first wall 24 and the second wall 28. In one embodiment, the infuser 10 is configured to receive a deformation force F comprising application of a tension stress between the first wall 24 and the second wall 28 to deform the internal volume 14 from the first form to a second form comprising proximation of the third wall 30. In one embodiment, a deformation force comprises application of torque between the first wall 24 and the second wall 28 to compress the internal volume 14 from the first form to a second form comprising proximation of the first wall 24, the second wall 28, and the third wall 30. According to various embodiments, the infuser 10 is configured to allow a user to apply multiple deformation forces F. For example, a user may apply repeated or varied deformation forces F to the infuser to thereby muddle the infusion item.

As described in more detail below, in certain embodiments, the above muddling action may be further promoted when one or both of the first wall 24 and the second wall 28 comprise muddling features 42 configured to compressingly engage the infusion component. For example, muddling features 42, such as one or more rigid structures defined on one or more walls 24, 28, 30, may be positioned within the internal volume 14 such that deformation of the internal volume causes the rigid structure to engage the infusion item and thereby assist in mechanically muddling the infusion item.

When the internal volume 14 is transitioned from the first form to the second form, the hollow body 12 is configured to deform the internal volume 14 between one or more walls 24, 28, 30 of the hollow body 12, which, in operation, may compress an infusion item positioned therebetween to promote or assist extraction of desirable infusion components from the infusion item. For example, in one embodiment, deformation of the internal volume 14 compresses the internal volume 14 such that a distance between one or more walls 24, 28, 30 defining the internal volume 14 changes, thereby deforming the internal volume 14 therebetween, e.g., to compresses the infusion component between one or more walls 24, 28, 30. Accordingly, deformation of the internal volume 14 may compress the infusion item to beneficially promote extraction of infusion components such as juices and flavors derived from the infusion item. Upon release, the infusion component may therefore be mixed or infused with a surrounding liquid, e.g., within a portion of the internal volume 14 or the external environment. For example, the external environment may include or contain a liquid for infusion. In some embodiments, the filter 18 may be permeable to the liquid such that the liquid may move between the external environment and the internal volume 14.

In various embodiments, deformation of the internal volume 14 comprises a relative movement between one or more walls 24, 28, 30 or portions thereof. For example, in the embodiment illustrated in FIGS. 1A-1D, the first end 22 and the second end 26 proximate when the internal volume 14 deforms. Additionally, deformation of the internal volume 14 comprises relative movement of the first wall 24 or portions thereof moving relative to the second wall 28 as well as the third wall 30. The relative movement results in a change in a distance between the walls 24, 28, 30 configured to compress an infusion item within the internal volume 14. According to certain embodiments, the relative movement may be the result of a deformation, e.g., collapse, fold, bend, stretch, or strain, of the one or more walls 24, 28, 30. In one embodiment, the hollow body 12 of the infuser 10 is configured such that the relative movement is provided by the structure or composition of the one or more walls 24, 28, 30. For example, one or more walls 24, 28, 30 may include a deformable portion configured to proximate one or more walls 24, 28, 30. In various embodiments, one or more walls 24, 38, 30 comprises an elastomeric material that is deformable between a first conformation and a second conformation to transition the internal volume 14 between the first form and the second form. For example, one or more walls 24, 28, 30 may be deformable from a first confirmation to a second confirmation such that one or more walls 24, 28, 30 proximate when deformed to engage and apply mechanical compression to an infusion item contained therebetween within the internal volume 14. The compression may be configured to squeeze, tear, or otherwise muddle, for example, the infusion item to promote extraction or release of the infusion component from the infusion item. In one embodiment, one or more walls 24, 28, 30 are mechanically movable, e.g., along a guide, groove, or rail, to proximate the one or more walls 24, 28, 30 with another wall 24, 28, 30 when moved along the rail. For example, in one embodiment, one or more walls 24, 28, 30 defining the internal volume 14 are relatively moveable to deform the internal volume 14 to thereby compressingly engage the infusion item contained within the internal volume 14 as described above.

In the embodiment illustrated in FIGS. 1A-1D, the infuser 10 comprises a hollow body 12 that includes one or more walls comprising a first wall 24, a second wall 28, and one or more third walls 30 that define the internal volume 14. The third wall 30 comprises an elastomeric material and is configured to elastically deform between an original or first conformation, as shown in FIGS. 1A and 1B, and a deformed or second conformation, as shown in FIGS. 1C and 1D, upon application of a deformation force F. That is, the third wall 30 is configured to deform to change a distance between the first wall 24 and the second wall 28 and compress the internal volume 14 therebetween. For example, in one embodiment, a deformation force F may deform the third wall 30 to deform the internal volume 14 from the first form to the second form comprising a change in a distance between the first wall 24 and the second wall 28. Deformation of the one or more walls 24, 28, 20 may be configured to apply mechanical compression to an infusion item contained therein to squeeze, tear, or otherwise muddle, for example, the infusion item and thereby promote extraction of the infusion component from the infusion item

In operation, the first wall 24 may be configured to collapse toward the second wall 28 when the third wall 30 is elastically deformed from the first conformation to the second conformation as shown in FIGS. 1C and 1D. For example, the third wall 30 may be configured to elastically deform, e.g., substantially reversibly deform, from the first conformation, coinciding with the first form of the internal volume, as shown in FIGS. 1A and 1B, to the second conformation, coinciding with the second form of the internal volume 14, as shown in FIGS. 1C and 1D, upon application of the deformation force F and return to the first conformation, coinciding with the first form of the internal volume 14, upon removal of the deformation force F. Thus, the hollow body 12 of the infuser 10 may be configured to muddle the infusion item between the first wall 24 and second wall 28 when the internal volume 14 is transitioned between the first form and the second form. Additionally, according to some embodiments, sequential application and removal of deformation forces F may be used to further muddle the infusion item and promote extraction of an infusion component.

In one embodiment, one or both of the first wall 24 and the second wall 28 are rigid to provide a platform upon which the deformation force F may be applied. In certain embodiments, one or both of the first wall 24 and the second wall 28 comprise elastomeric material configured to be elastically deformed upon application of a deformation force. In some such embodiments, the one or more third walls 30 may comprise a rigid material. In other embodiments, however, the one or more third walls 30 also comprise elastomeric material configured to be elastically deformed upon application of the deformation force.

According to various embodiments, the magnitude or angle of the deformation force applied to the hollow body 12 results in variable deformation of the internal volume 14. For example, in one embodiment, a deformation force of greater magnitude increases the deformation of the internal volume 14 between one or more walls 24, 28, 30. Similarly, in some embodiments, the degree of compression or change in distance between the one or more walls 24, 28, 30 in the second conformation may not be uniform. Thus, the hollow body may be configured to transition to a variety of variable second forms depending on an angle the deformation force is applied in order to accomplished a variety of compression angles with respect to the muddling action of the infuser 10. For example, in at least one embodiment, the hollow body 12 comprises an internal volume 14 configured to be deformable to a second conformation comprising walls 24, 28, 30 that are relatively rotated with respect to each other when a deformation force comprising rotation angles is applied. That is, in one embodiment, one or more walls 24, 28, 30 of the infuser 10 may be moved or rotated relative to another wall 24, 28, 30 when the internal volume 14 is deformed. For example, the first wall 24 and the second wall 28 may be rotated relative to each other to muddle the infusion item. According to various embodiments, the one or more third walls 30 may be deformable to allow the rotation. Rotation may also be provided by a rotation joint, e.g., assisted by bearings, between the first end 22 and second end 24. In some such embodiments, the internal volume 14 may also be configured to be deformable to a second conformation comprising proximated and relatively rotated walls 24, 28, 30 compared to the first form of the internal volume 14.

In certain embodiments, deformation of the internal volume 14 from the first forth to the second form includes a reduction in the internal volume 14 configured to promote extraction of the infusion component via an increase in a pressure to which the infusion item is exposed, which in some embodiments may include increased mechanical pressure. For example, in certain embodiment the infuser 10 is coupled with a system that is sufficiently open such that restriction on fluid flow between the internal volume 14 and the system is negligible and the internal volume 14 may decrease in volume when deformed to provide greater overall proximation of walls 24, 28, 30. In certain embodiments, the deformable material of the hollow body 12 is configured to stretch or expand, which may or may not increase the internal volume 14, when a deformation force is applied. In one embodiment, the hollow body 12 includes or is associated with a fluid port, exhaust port, an auxiliary chamber, valve, or an arrangement of chambers or valves configured to allow fluid to be released or move through the internal volume 14 or a fluidically coupled volume, such as a second or third volume. For example, when the deformation force F is applied to deform the internal volume 14, the internal volume 14 may decrease in volume. Fluid may escape or exhaust the internal volume or a fluidically coupled volume through a valve to allow the decrease in volume and may be allowed to reenter the internal volume 14 when the force F is removed and the internal volume 14 returns to its uncompressed form.

As introduced above, the infuser 10 may comprise one or more muddling features 42 positioned within the internal volume 14. In various embodiments, for example, one or more walls 24, 28, 30, the partition 16, or the filter 18 includes one or more muddling features 42. In the illustrated embodiment, the muddling features 42 comprise one or more internally positioned structures formed on the first wall 24 and the second wall 28. In certain embodiments, the muddling features 42 are structured and dimensioned to compress or apply differential pressure to tissue of the infusion item to muddle, e.g., squeeze, puncture, shred, mash, or otherwise cause separation of, the infusion item, and thereby promote extraction of the infusion components. For example, the action of the muddling features 42 may increase the accessible surface area of the infusion item or provide an accessible route through which infusion components may be extracted from tissue of the infusion item. Although the type of muddling features 42 may vary by application, among the suitable structures and arrangements are raised or recessed features, e.g., bumps, ridges, teeth, or serrations. In various embodiments, the muddling features 42 may be formed on the walls 24, 28, 30, the partition 16, or filter 18 and may comprise similar or different material as the component upon which it is formed including, but not limited to, metals, alloys, ceramics, polymers, hard plastics, elastomers, rubbers, thermoplastics, and thermosets. In one embodiment, for example, the muddling features 42 comprise metal structures formed on one or more of the walls 24, 28, 30. The muddling features 42 may be positioned in various patterns within the internal volume 14 and may comprise characteristic patterns and structures configured for specialized or enhanced muddling of certain types of infusion items. For example, the number, length, thickness, surface texture, smoothness, pattern, and orientation of muddling features 42 may be designed for optimal extraction of infusion components.

It is noted that, although generally referred to as an internal volume 14 herein, it will be understood that the internal volume 14 may also comprise two or more internal volumes 14 or compartments. That is, in certain embodiments, the internal volume 14 comprises a plurality of internal compartments. Each internal compartment may be completely or partially partitioned from other internal compartments. For example, in one embodiment, the internal volume 14 comprises a plurality of compartments configured to receive infusion items. Such infusers may beneficially allow a user to select an optimal sized compartment for one or more infusion items. For example, a first larger compartment of the internal volume 14 may be dimensioned to receive larger items such as fruit and a second smaller compartment of the internal volume 14 may be dimensioned to receive smaller items such as herbs.

In certain embodiments, compartments within the internal volume 14 may include muddling features 42 configured to contact and muddle infusion items when the first internal volume 14 is deformed as described above. In some embodiments, for example, various compartments comprise various combinations of muddling features 42 that may comprise one or more specialized dimensions and arrangements configured to provide enhanced suitability for extracting infusion components from a particular type of infusion item or tissues. For example, in one embodiment, the first compartment of the internal volume 14 comprises fewer muddling features 42 configured with greater contacting surface area compared to a second compartment of the internal volume 14. As such, when the particular type of infusion item is positioned within the internal volume 14 and therein compressed against the muddling features 42, more complete or localized contact or compression action may be applied to promote extraction of the infusion component.

In various embodiments, the base 32 provides a stable position against which a deformation force may be applied. For example, the base 32 may be positioned against a surface and the deformation force may be applied to the second wall 28 or one or more third walls 30 relative to the base 32 to compress the internal volume 14. In some embodiments, the base 32 is configured to be more rigid than the one or more third walls 30 to increase stability of the infuser 10. For example, in one embodiment, the one or more third walls 30 and the first wall 24 comprise the same or similar materials, however, the thickness of the first wall 24 is greater than the thickness of the one or more third walls 30.

As introduced above, in various embodiments, the infuser 10 is configured to couple to an external environment through the filter 18. In some such embodiments, the infuser comprises a fitting 34, 36 configured to mount or otherwise stably associate the infuser 10 with the external environment to, for instance, allow a user to conveniently apply the deformation force to compress the internal volume. For example, the infuser 10 may comprise any suitable fittings known in the art such as clips, tabs, grooves, or threads which may be, for example, configured for rotational, snap, or compression fitment with an external environment.

FIGS. 2-4 illustrate perspective views of one embodiment of an infusion device 100 including an infuser 110 comprising a first hollow body portion 112 defining a first internal volume 114 coupled to an external environment. In the illustrated embodiment, the external environment comprises a container or second hollow body 144 defining a second internal volume 144. It will be appreciated that the present disclosure is not limited to the illustrated embodiment. For example, in one embodiment, the infuser 110 may be coupled to or stably associated with a beverage pitcher such that the infuser 110 may be compressed similar to a pump or elastomeric bulb to muddle the infusion item for release into the pitcher.

Thus, according to various embodiments described herein, an infusion device 100 comprises an infuser 110 comprising a container having a first hollow body portion 112 and a second hollow body portion 144. The first hollow body portion 112 defines a first internal volume 114 at least partially separated from a second internal volume 146 defined by the second hollow body portion 144 by a partition 116. For example, in one embodiment, the infusion device 100 comprises or is configured to receive a partition 116 comprising a filter 118. As such, the filter 118 may be removable or integral to, for example, the second hollow body portion 144 or mountable with respect to the first hollow body portion 112. The first hollow body portion 112 is configured to receive an infusion item within the first internal volume 114. The second hollow body portion 144 is configured to receive the liquid to be infused, which may also permeate the filter 118 into the first internal volume 114 when the filter 118 is permeable to the liquid. In any event, the first internal volume 114 and the second internal volume 118 are at least partially fluidically coupled through the filter 118. For example, the filter 118 may be configured to be permeable to the infusion component to allow free flow of the infusion component between the first internal volume 114 and the second internal volume 146. Accordingly, when the first internal volume 114 is compressed, extraction of the infusion components, as described above, promotes infusion of the liquid to produce the infusion.

While not illustrated, in various embodiments, the first hollow body portion 112 may be coupled between two hollow body portions, each defining an internal volume that is partitioned from the first internal volume 114 by filters 118. In one such embodiment, one or both of the hollow body portions may also comprise an elastomeric material configured to compress their respective internal volumes to drive transport or circulation of liquid through the first internal volume 114.

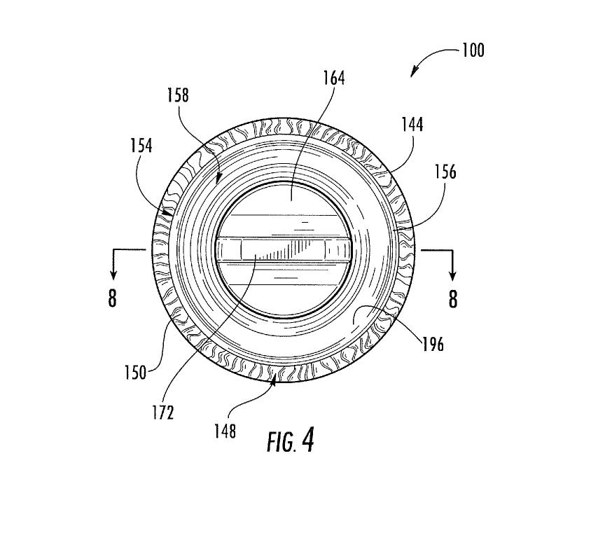

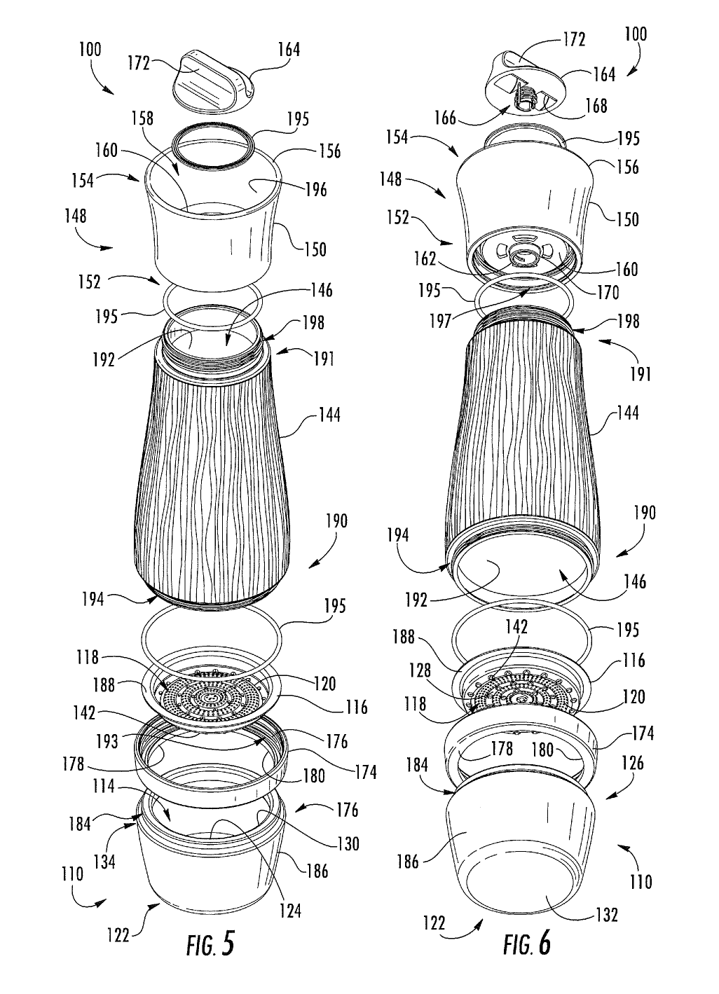

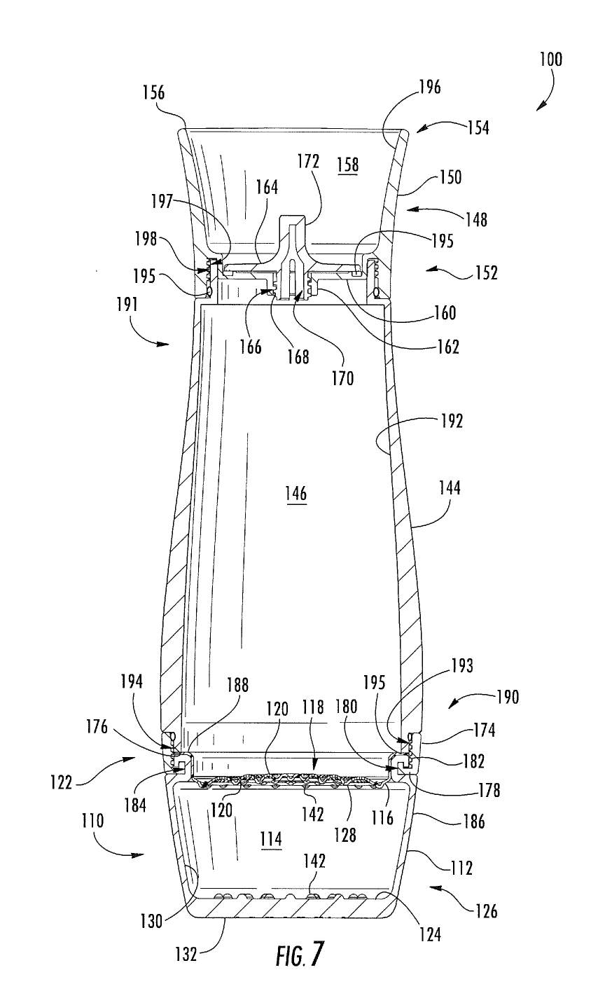

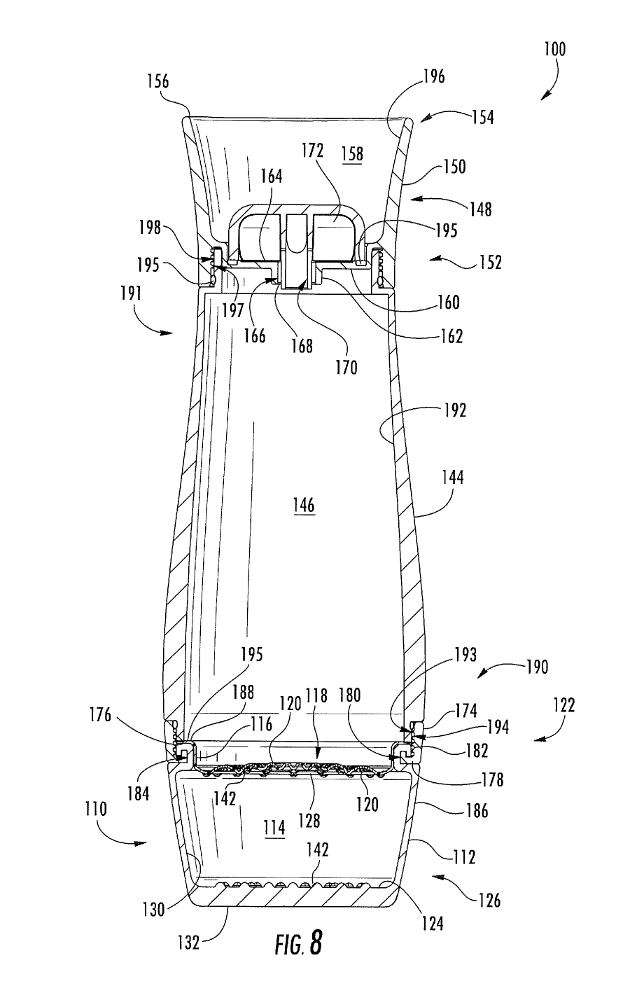

The embodiment illustrated in FIGS. 2-4 further includes a cap 148 comprising a third hollow body portion 150. With specific reference to FIG. 4, illustrating a top view of the infusion device 100, the third hollow body portion 150 comprises a first end 152 configured to sealingly engage the second hollow body portion 144 and a second open end and defining an annular rim 156 and a third internal volume 158 defined therebetween. As described in more detail below with respect to FIGS. 5-9, the first end 152 comprises a cover plate 160 defining a fluid port 162. The cap 148 further comprises a plug 164 having a fitting 166 comprising threads 168 defined about an outer circumference outer of the plug 164 configured to threadingly engage a complementary threaded fitting 170 defined about an inner circumference of the fluid port 162. The plug 164 further defines a grip 172 allowing a user to manipulate the plug 164 to thereby selectively engage or disengage the plug 164 from the fluid port 162. As such, the user may disengage the plug 164 to add or remove liquid or infusion. Additionally, as described in more detail below, a user may further use the cap 148 as a convenient cup from which to consume the infusion when either coupled or decoupled from the second hollow body portion 144.

Referring to FIGS. 5 and 6, illustrating exploded views of one embodiment of the infusion device 100 illustrated in FIGS. 2-4, and FIGS. 7 and 8, illustrating cross-section views of the infusion device 100 taken along line 7-7 of FIG. 3 and line 8 of FIG. 4, respectively, the infusion device 100 comprises an infuser 110 comprising a first hollow body portion 112 defining a first internal volume 114, a second hollow body portion 144 defining a second internal volume 146, and a third hollow body portion 150 defining a third internal volume 158. The first hollow body portion 112 comprises a first closed end 122 defining a base 132 and a first wall 124 and a second end 126 comprising a ring fitting 174. The ring fitting 174 includes a threaded inner circumference 176 and a protruding annular lip 178. The protruding annular lip 178 extends inward to a reduced diameter 180 with respect to the threaded inner circumference and includes an annular groove 182. When assembled, the protruding annular lip 178 is configured to be movably retained within a complementary groove 184 defined about the outer surface 186 of the first hollow body portion. The first hollow body portion 112 further comprises a third wall 130 extending between the first end 122 and the second end 126. The infuser 110 further comprises a partition 116 including a filter 118 that is mountable to the first hollow body portion 112. The partition 116 includes an annular lip 188 extending about its outer circumference configured to be positioned between the second end 126 of the first hollow body portion 112 and a first end 190 of the second hollow body portion 144.

The second hollow body portion further comprises a second end 191, and a wall 192 extending therebetween along its inner circumference. The first end 190 is configured to couple to a fitting 193 comprising threaded inner circumference fitting 176 defined at the second end 122 of the first hollow body portion 112 about a complementary threaded fitting 194 defined along an outer circumference of the first end 190 of the second hollow body portion 144. An improved seal between the first and second hollow body portions 112, 144 may be provided by a gasket 195 comprising an o-ring positioned between the first and second hollow body portions 112, 144. In use, the second internal volume 146 defined by the second hollow body portion 144 may comprise a reservoir dimensioned to receive or contain the liquid or infusion. It is to be appreciated that while the illustrated infusion device 100 comprises a generally cylindrical body having one or more circumferential cross-sections, in certain embodiments, the body may comprise other shapes and cross-sections. For example, in various embodiments, the body may define one or more regular or irregular shapes or cross-sections. In one embodiment, the third wall 130 of the first hollow body portion 112 or the wall 192 of the second hollow body portion 144, for example, may comprise two or more walls that are angularly positioned with respect to each other. In some embodiments, the body or an outer surface thereof may comprise one or more ergonomic features configured to assist a user in handling the infusion device 100. For example, in one embodiment, the second hollow body portion 144 comprises one or more ridges or grip features disposed at or along its outer surface. Similarly, in various embodiments, the body may comprise or be coated with a material configured to be deformable to the hands of the user, e.g., a soft or flexible rubber, foam, elastomer, or polymer, such as a silicone material. In certain embodiment, the coating may further comprise a thermal insulator configured to thermally insulate one or more internal volumes defined within the body.

Still referring to FIGS. 5-8, the cap 148 comprises the third hollow body portion 150. The third hollow body portion 150 comprises a first end 152 and a second end 154 and a wall 196 extending therebetween. The first end 152 is configured to sealingly engage the second end 191 of the second hollow body portion 144 about respective fittings 197, 198 comprising complementary threaded portions defined on their respective inner and outer circumferences. An improved seal may be provided by a gasket 195 comprising an o-ring positionable between the second and third hollow body portions 112, 144. The cap 148 further includes the coverplate 160 that defines the fluid port 162 and the plug 164 configured to threadingly engage the threaded fitting 170 defined about the inner circumference of the fluid port 162. An improved seal may be provided by a gasket 195 comprising an o-ring positionable between the plug 164 and the coverplate 160.

As introduced above, the plug 164 defines a grip 172 allowing a user to manipulate the plug 164 to thereby selectively engage or disengage the plug 164 from the fluid port 162. As such, the user may disengage the plug 164 to add or remove liquid or infusion. In various embodiments, the fluid port 162 may be configured to receive a straw allowing the user to consume the infusion. In one embodiment, the straw or a pourer comprising a fitting configured to engage the fluid port 162 may be provided. In the illustrated embodiment, the cap 148 may be used as a cup from which the infusion may be consumed. For example, the user may remove the cap and pour the infusion into the cap or may remove the plug 162 such that the infusion may be released from the first internal volume 114 and the second volume 144 when the infusion device 100 is tilted.

In various embodiments, the infusion device 100 comprises one or more modular components. For example, the first hollow body portion 112, second hollow body portion 144, and third hollow body portion 150 may be provided as separate replaceable components. Similarly, in one embodiment, the various fittings described above to couple or stably associate the hollow body portions 112, 144, 150 may comprise multiple couplings or universal couplings configured to allow a user to selectively couple various embodiments of hollow body portions to, for example, selectively mix and match various additional hollow body portions to create a customized or personalized infusion device. For example, if a user desires a greater first internal volume 114, the user may couple a first hollow body portion 112 defining a greater first volume to the second hollow body portion 144.

As one having skill in the art will appreciate upon reading this disclosure, the particular arrangements of the various features of the infusers, infusion devices, and components thereof disclosed herein are merely exemplary. It is further understood that such arrangements may be routinely varied by those having skill in the art depending on desired application. For clarity and brevity, however, Applicants have not illustrated all contemplated variations within the routine skillset of those skilled in the art. For example, in one embodiment, the second hollow body portion 144 comprises a closed or closable first end 190 having a pluggable fluid port 162. Similarly, while the hollow body portions illustrated in FIGS. 1-8 are shown as separable components, in various embodiments, a single component may comprise multiple hollow body portions. For example, the second hollow body portion 144 and the third hollow body portion 150 may comprise a single unit. Additionally, unless stated otherwise, the various features and their arrangement depicted in the illustrated embodiments are not to be interpreted as essential or required features. For example, in various embodiments, a cap 148 may comprise a plug 164 or a coverplate 160 configured to seal the second end 191 or a fluid port of the second hollow body portion 144. Thus, in one such embodiment, the infusion device 100 may not necessarily comprise a third hollow body portion 150.

According to various embodiments the presently described infusers, infusion devices, or components thereof are particularly configured for multiple use by virtue of their construction and durability. However, it is also contemplated that other embodiments of the present infusers, infusion devices, or components thereof may be configured for disposable or single use. Fittings configured for attachable or detachable connections of the present infusers, infusion devices, or components thereof, e.g., connections between hollow body portions, are presently illustrated. However, non-detachable integrated connections are also contemplated. Accordingly, embodiments of the presently described infusers, infusion devices, and components thereof may be configured for single use and/or multiple use with either detachable and/or non-detachable integral configurations or arrangements, without limitation, and all combinations of such configurations are contemplated to be within the scope of the present disclosure. For example, in one embodiment, the filter 18, 118 and/or coverplate 160 or plug 164 may be non-detachably integrated with one or more hollow body portions 112, 144, 150 or may be provided as separate components, which can be attached to the infusion device 100 or body thereof.

In various embodiments, the above described infusers and infusion devices may be configured as handheld infusion devices. For example, in one embodiment, the infusion device comprises a portable infusion bottle in which a user may conveniently concoct a potable infusion.

In various embodiments, an infusion device comprises a first container defining a first volume and a second container defining a second volume. The first container may be configured to receive an infusion item within the first volume. In one embodiment, the first container is configured to couple to a second container such that the first volume and the second volume are at least partially fluidcally coupled. In use, for example, a liquid to be infused with the infusion components derived from the infusion item may be received within the second volume. In one embodiment, the liquid may pass and therefore also be received within the first volume. For example, the liquid may steep the infusion item. The second hollow body portion is dimensioned to provide a reservoir for liquid to be infused with one or more infusion components contained in the first hollow body portion. Thus, in certain embodiments, the first hollow body portion is at least partially fluidically coupled with the second hollow body portion through the filter such that the infusion components may be released from the first hollow body portion into the second hollow body portion. In one embodiment, the infusion device further comprise a third hollow body portion comprising a cap configured to couple to the first end of the second hollow body portion and a plug to seal a liquid port extending between the second and third internal volumes.

What is claimed is:

1. An infuser comprising:
a first hollow body;
a filter permeable to an infusion component derived from an infusion item; and
a first internal volume at least partially defined by the first hollow body and the filter, wherein the first internal volume is dimensioned to receive the infusion item therein, and wherein the first hollow body comprises an elastomeric material configured to deform upon application of a deformation force to deform the first internal volume.

2. The infuser of claim 1, wherein deformation of the elastomeric material to deform the first internal volume is configured to compress the hollow body against the infusion item to promote extraction of the infusion component from the infusion item when the infusion component is received within the first internal volume.

3. The infuser of claim 2, wherein the first hollow body further comprises one or more muddling features positioned within the first internal volume structured to muddle the infusion item when the hollow body portion is compressed against the infusion item.

4. The infuser of claim 2, wherein the infuser comprises a fitting configured to couple the first hollow body to a second hollow body, wherein the second hollow body defines a second internal volume configured to receive a liquid to be infused with the infusion component, and wherein, when the first hollow body is coupled to the second hollow body, the filter is positioned between the first internal volume and the second internal volume.

5. The infuser of claim 4, further comprising a partition, wherein the filter comprises a plurality of liquid permeable channels formed through the partition, and wherein the partition comprises one or more muddling features positionable within the first internal volume structured muddle the infusion item when the first hollow body portion is compressed against the infusion item.

6. The infuser of claim 5, wherein at least one of the partition and the second hollow body comprises a rigid material configured to transmit at least a portion of the deformation force.

7. The infuser of claim 1, wherein the first hollow body comprises one or more walls that define the internal volume, and wherein the one or more walls comprise,
a first wall portion;
a second wall portion; and
a third wall portion, wherein at least the third wall portion comprises the elastomeric material and is configured to be elastically deformable between a first conformation and a second conformation, and wherein a distance between the first wall portion and the second wall portion is changed in the second conformation.

8. The infuser of claim 7, wherein the third wall portion is configured to elastically deform from the first conformation to the second conformation upon application of the deformation force and return to the first conformation upon removal of the deformation force.

9. The infuser of claim 8, wherein the second conformation comprises a variable conformation at least partially dependent upon at least one of an angle and magnitude of the deformation force applied.

10. The infuser of claim 8, wherein the second conformation comprises a plurality of second conformations, and wherein, in at least one of the plurality of second conformations, the first wall portion is rotated with respect to the second wall portion.

11. An infusion device for infusing a liquid with an infusion component derived from an infusion item, the infusion device comprising:
a first hollow body portion defining a first internal volume configured to receive the infusion item therein, wherein the first hollow body portion is deformable upon application of a deformation force to transition the first internal volume from a first form to a second form, and wherein the first hollow body is configured to compress the infusion item within the first internal volume when transitioned from the first form to the second form to promote extraction of the infusion component from the infusion item;
a second hollow body portion defining a second internal volume configured to receive the liquid to be infused, and wherein the second hollow body portion is configured to stably associate with the first hollow body portion; and
a partition configured to be positioned between the first internal volume and the second internal volume when the second hollow body portion is stably associated with the first hollow body portion, wherein the partition comprises a filter configured to be permeable to the infusion component, and wherein the second internal volume is configured to receive the infusion component from the first hollow body portion.

12. The infusion device of claim 11, further comprising one or more muddling features configured to be positioned within the first internal volume, and wherein the one or more muddling features are structured to muddle the infusion item when the first hollow body compresses the infusion component.

13. The infusion device of claim 12, wherein the first hollow body portion comprises a first end, a second end, and one or more walls positioned therebetween defining the first internal volume, wherein the one or more walls comprise an elastomeric material configured to reversibly deform when the deformation force is applied between the first end and the second end to transition the first internal volume from the first form to the second form, and wherein a distance between the first end and the second end is reduced when the first internal volume is transitioned from the first form to the second form.

14. The infusion device of claim 13, wherein the first hollow body comprises the partition and the one or more walls comprise a first wall positioned at a first end of the first hollow body, a second wall positioned at a second end of the first hollow body, and one or more third walls positioned therebetween, wherein the one or more third walls comprise an elastomeric material configured to reversibly deform when the deformation force is applied between the first end and the second end to transition the first internal volume from the first form to the second form, and wherein a distance between the first wall and the second wall is reduced when the first internal volume is transitioned from the first form to the second form.

15. The infusion device of claim 14, wherein at least one of the first wall and the second wall comprise one or more of the one or more muddling features.

16. The infusion device of claim 15, wherein the second hollow body portion comprises a rigid material configured to at least partially transmit the deformation force at the second end.

17. The infusion device of claim 15, wherein the one or more muddling features comprise a metal.

18. The infusion device of claim 15, wherein the elastomeric material comprises a silicone.

19. The infusion device of claim 12, wherein the infusion device further comprises a cap configured to couple to the second hollow body and defining a fluid port pluggable to fluidically seal the first and second internal volumes, wherein the cap comprises a removable cup for consuming an infused liquid, and wherein the removable cup comprises a third hollow body portion defining a third internal volume and comprising a first closed end comprising a coverplate defining the fluid port and a second open end defining an annular rim.

20. The infusion device of claim 11, wherein the infusion device comprises a handheld infusion bottle.
